(19) United States
(12) Patent Application Publication
(10) Pub. No.: US 2017/0293695 A1
(43) Pub. Date: Oct. 12, 2017

(54) OPTIMIZING SIMILAR ITEM RECOMMENDATIONS IN A SEMI-STRUCTURED ENVIRONMENT

(71) Applicant: eBay Inc., San Jose, CA (US)

(72) Inventors: Yuri Michael Brovman, New York, NY (US); Marie Jacob, New York, NY (US); Natraj Srinivasan, New York, NY (US); Stephen Neola, Jersey City, NJ (US); Daniel Galron, New York, NY (US); Ryan Snyder, New York, NY (US); Paul Wang, New York, NY (US)

(21) Appl. No.: 15/190,279

(22) Filed: Jun. 23, 2016

Related U.S. Application Data
(60) Provisional application No. 62/321,451, filed on Apr. 12, 2016.

(51) Int. Cl. G06F 17/30

(52) U.S. Cl. CPC G06F 17/30941; G06F 17/30911; G06F 17/30938

(57) ABSTRACT

Systems, methods and media are provided for optimizing similar item recommendations in a semi-structured environment. In one embodiment a system includes at least one processor and a memory storing instructions that, when executed by the at least one processor, cause the system to perform operations comprising, at least identifying a seed item; retrieving a subset of recommended items relevant to the seed item; and ranking the subset of recommended items based on an item conversion probability, wherein the ranking of the subset of recommended items is based on a machine learning technique, and wherein a binary or multi-class label is used as training input to the machine learning technique.

### CLAIM OF PRIORITY

This patent application claims the benefit of priority, under 35 U.S.C. Section 119(e), to Brovman, U.S. Provisional Patent Application Ser. No. 62/321,451, entitled “OPTIMIZING SIMILAR ITEM RECOMMENDATIONS IN A SEMI-STRUCTURED MARKETPLACE TO MAXIMIZE CONVERSION,” filed on April 12, 2016 (Attorney Docket No. 2043.K08PRV), which is hereby incorporated by reference herein in its entirety.

### BACKGROUND

This disclosure generally addresses technical problems associated with optimizing similar item recommendations in a semi-structured environment. In one example, these problems are addressed more specifically in formulating product recommendations in a large semi-structured networked marketplace. Technical problems such as data limitations imposed by a variable inventory and lack of structured information about product listings renders traditional collaborative filtering algorithms difficult to use.

### BRIEF SUMMARY

This disclosure teaches technical solutions in overcoming some of the aforementioned data limitations in order to produce product recommendations in real time with a combination of a customized scalable architecture as well as a widely applicable machine learned ranking model. A point-wise ranking approach is utilized to reduce a ranking problem to a binary classification solution optimized on past user purchase behavior. This disclosure presents details of a sampling strategy and feature engineering that have been effective in lifting both purchase through rate (PTR) (also termed item conversion herein) and revenue.

Recommendations drive a considerable portion of site revenue, and ensure that users stay interested and engaged in content, for extended periods of time. Some online marketplaces publish warehouse products in a documented catalog, while others, for example semi-structured marketplaces, publish more diverse listings ranging anywhere from a new iPhone (a specific product with structured data attributes)to off-hand antique items with no known characteristics. With over 800 million active listings at any given time as well as over 150 million active buyers, this semi-structured market place is well-known for heavy-tailed distribution of items. A large number of listings are unique, unidentified items that are popular among niche buyers. In addition, multiple item conditions and selling formats make serving relevant recommendations significantly harder.

### BRIEF DESCRIPTION OF THE DRAWINGS

In order more easily to identify the discussion of any particular element or act, the most significant digit or digits in a reference number refer to the figure number in which that element is first introduced.

FIG. 1 is a block diagram illustrating a networked system, according to some example embodiments.

FIG. 2 is a block diagram illustrating components of a machine, according to some example embodiments, able to read instructions from a machine-readable medium (e.g., a machine-readable storage medium) and perform any one or more of the methodologies discussed herein.

FIG. 3 is a block diagram illustrating a representative software architecture software architecture, which may be used in conjunction with various hardware architectures herein described.

FIG. 4 illustrates an example item (or product) page 400 showing similar item recommendations above the fold (i.e. initially visible in a screen without scrolling), in accordance with one embodiment.

FIG. 5 illustrates an example architecture 500 of a merchandising back-end platform, in accordance with one embodiment. In this example, offline jobs are marked by dashed lines.

FIG. 6 illustrates example histograms 600 showing class separation of a price feature with a) non-clicked/clicked and b) non-clicked/purchased sampling strategies, in accordance with example embodiments.

FIG. 7 illustrates at 700 a Table 1 indicating class label options for binary classifier and KL divergence for a price feature, in accordance with an example embodiment.

FIG. 8 illustrates an example histogram 800 of a price ratio and Cauchy fit, in accordance with an example embodiment.

FIG. 9 illustrates at 900 a Table 2 indicating classification and ranking metrics, in accordance with example embodiments.

FIG. 10 illustrates at 1000 a Table 3 indicating results of an A/B test showing lift in operational metrics, in accordance with an example embodiment.

FIG. 11 illustrates a flow chart of a method, in accordance with an example embodiment.

### DETAILED DESCRIPTION

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra-books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to logic having boundaries defined by function or subroutine calls, branch points, application program interfaces (APIs), or other technologies that provide for the partitioning or modularization of particular processing or control functions. Components are typically combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least sonic of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, eBay Inc., All Rights Reserved.

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

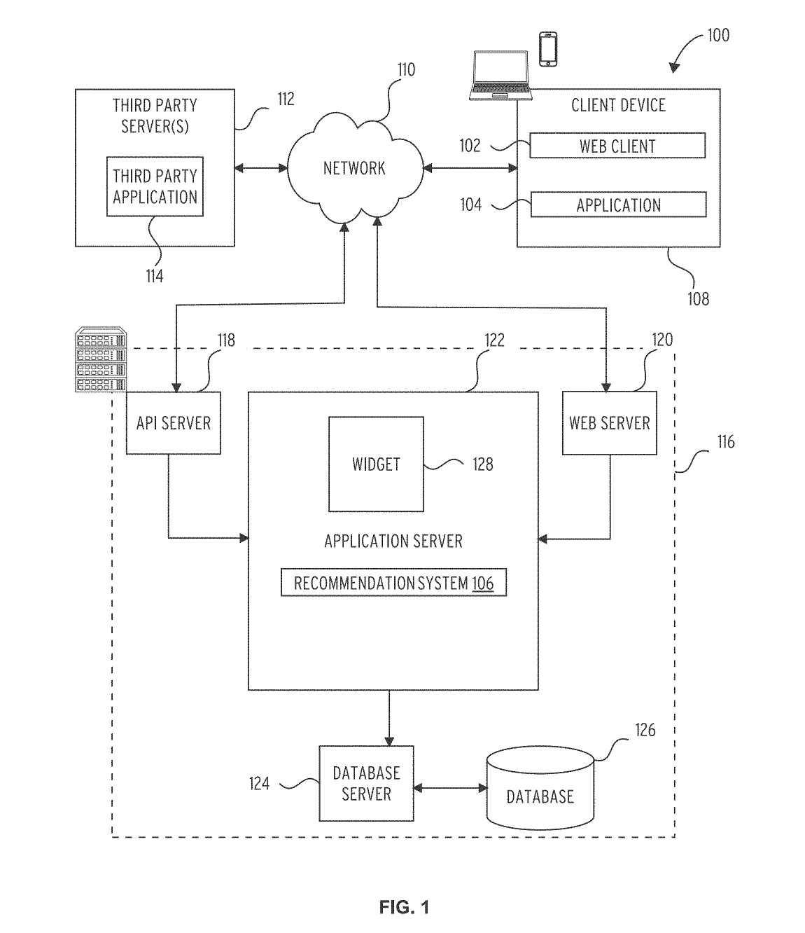

With reference to FIG. 1, an example embodiment of a high-level SaaS network architecture 100 is shown. A networked system 116 provides server-side functionality via a network 110 (e.g., the Internet or wide area network (WAN)) to a client device 108. A web client 102 and a programmatic client, in the example form of an application 104 are hosted and execute on the client device 108. The networked system 116 includes and application server 122, which in turn hosts a recommendation system 106 that provides a number of functions and services to the application 104 that accesses the networked system 116. The application 104 also provides a number of interfaces described herein, which present output of the tracking and analysis operations to a user of the client device 108.

The client device 108 enables a user to access and interact with the networked system 116. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An Application Program Interface (API) server 118 and a web server 120 are coupled to, and provide programmatic and web interfaces respectively, to the application server 122 The application server 122 hosts a recommendation system 106, which includes components or applications. The application server 122 is, in turn, shown to be coupled to a database server 124 that facilitates access to information storage repositories (e.g., a database 126). In an example embodiment, the database 126 includes storage devices that store information accessed and generated by the recommendation system 106.

Additionally, a third party application 114, executing on a third party server 112, is shown as having programmatic access to the networked system 116 via the programmatic interface provided by the Application Program Interface (API) server 118. For example, the third party application 114, using information retrieved from the networked system 116, may support one or more features or functions on a website hosted by the third party.

Turning now specifically to the applications hosted by the client device 108, the web client 102 may access the various systems (e.g., recommendation system 106) via the web interface supported by the web server 120. Similarly, the application 104 (e.g., an “app”) accesses the various services and functions provided by the recommendation system 106 via the programmatic interface provided by the Application Program Interface (API) server 118. The application 104 may, for example, an “app” executing on a client device 108, such as an iOS or Android OS application to enable user to access and input data on the networked system 116 in an off-line manner, and to perform batch-mode communications between the programmatic client application 104 and the networked system networked system 116.

Further, while the SaaS network architecture 100 shown in FIG. 1 employs a client-server architecture, the present inventive subject matter is of course not limited to such an architecture, and could equally well find application in a distributed, or peer-to-peer, architecture system, for example. The recommendation system 106 could also be implemented as a standalone software program, which do not necessarily have networking capabilities.

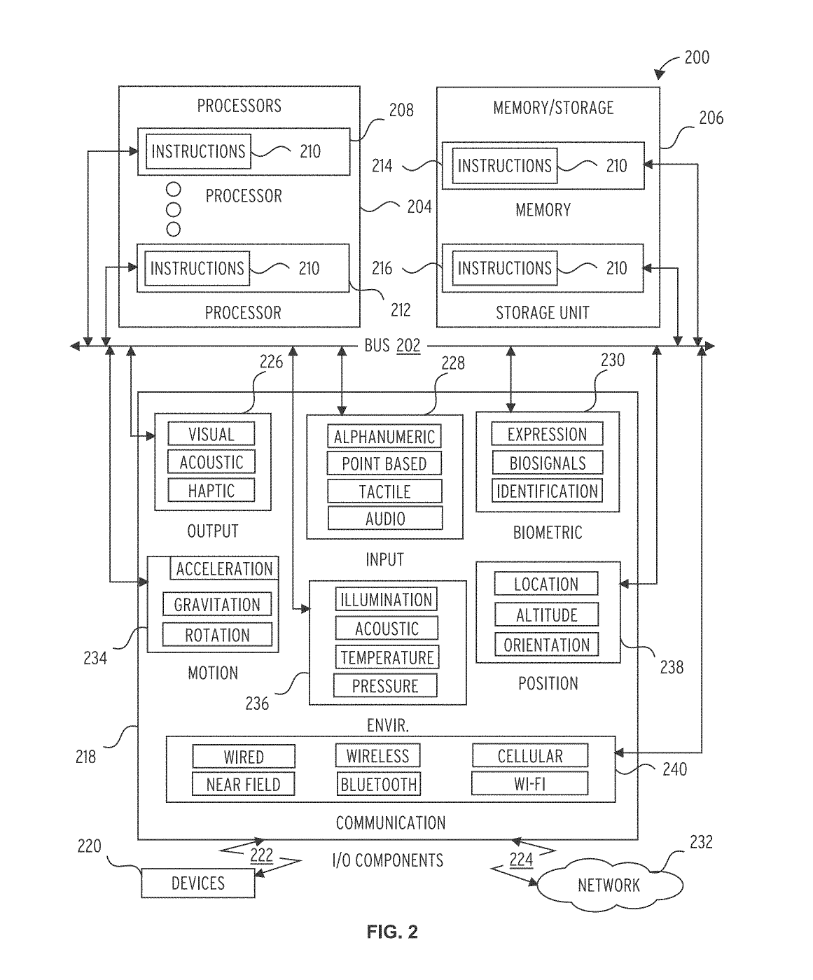

FIG. 2 is a block diagram illustrating components of a machine 200, according to some example embodiments, able to read instructions from a machine-readable medium (e.g., a machine-readable storage medium) and perform any one or more of the methodologies discussed herein. Specifically, FIG. 2 shows a diagrammatic representation of the machine 200 in the example form of a computer system, within which instructions 210(e.g., software, a program, an application, an apples, an app, or other executable code) for causing the machine 200 to perform any one or more of the methodologies discussed herein may be executed. As such, the instructions may be used to implement components or components described herein. The instructions transform the general, non-programmed machine into a particular machine programmed to carry out the described and illustrated functions in the manner described, in alternative embodiments, the machine 200 operates as a standalone device or may be coupled (e.g., networked) to other machines. In a networked deployment, the machine 200 may operate in the capacity of a server machine or a client machine in a server-client network environment, or as a peer machine in a peer-to-peer (or distributed) network environment. The machine 200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 210, sequentially or otherwise, that specify actions to be taken by machine 200. Further, while only a single machine 200 is illustrated, the term “machine” shall also be taken to include a collection of machines that individually or jointly execute the instructions 210 to perform any one or more of the methodologies discussed herein.

The machine 200 may include processors 204, memory memory/storage 206, and I/O components 218, which may be configured to communicate with each other such as via a bus 202. The memory/storage 206 may include a memory 214, such as a main memory, or other memory storage, and a storage unit 216, both accessible to the processors 204 such as via the bus 202. The storage unit 216 and memory 214 store the instructions 210 embodying any one or more of the methodologies or functions described herein. The instructions 210 may also reside, completely or partially, within the memory 214, within the storage unit 216, within at least one of the processors 204 (e.g., within the processor's cache memory), or any suitable combination thereof, during execution thereof by the machine 200. Accordingly, the memory 214, the storage unit 216, and the memory of processors 204 are examples of machine-readable media.

The I/O components 218 may include a wide variety of components to receive input, provide output, produce output, transmit information, exchange information, capture measurements, and so on. The specific I/O components 218 that are included in a particular machine will depend on the type of machine. For example, portable machines such as mobile phones will likely include a touch input device or other such input mechanisms, while a headless server machine will likely not include such a touch input device. It will be appreciated that the I/O components 218 may include many other components that are not shown in FIG. 2. The I/O components 218 are grouped according to functionality merely for simplifying the following discussion and the grouping is in no way limiting. In various example embodiments, the I/O components 218 may include output components output components 226 and input components 228. The output components 226 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 228 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 218 may include biometric components 230, motion components 234, environmental environment components 236, or position components 238 among a wide array of other components. For example, the biometric components 230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 234 may include acceleration sensor components (e.g., accelerometer), gravitation sensor components, rotation sensor components (e.g., gyroscope), and so forth. The environment components 236 may include, for example, illumination sensor components e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 238 may include location sensor components (e.g., a Global Position System (GPS) receiver component), altitude sensor components (e.g., altimeters or barometers that detect air pressure from which altitude may be derived), orientation sensor components (e.g., magnetometers), and the like,

Communication may be implemented using a wide variety of technologies. The I/O components 218 may include communication components 240 operable to couple the machine 200 to a network 232 or devices 220 via coupling 222 and coupling 224 respectively. For example, the communication components 240 may include a network interface component or other suitable device to interface with the network 232. In further examples, communication components 240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 220 may he another machine or any of a wide variety of peripheral devices (e.g., a peripheral device coupled via a Universal Serial Bus (USB)).

Moreover, the communication components 240 may detect identifiers or include components operable to detect identifiers. For example, the communication components processors communication components 240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 240, such as, location via. Internet Protocol (IP) geo-location, location via Wi-Fi®) signal triangulation, location via detecting a NFC beacon signal that may indicate a particular location, and so forth.

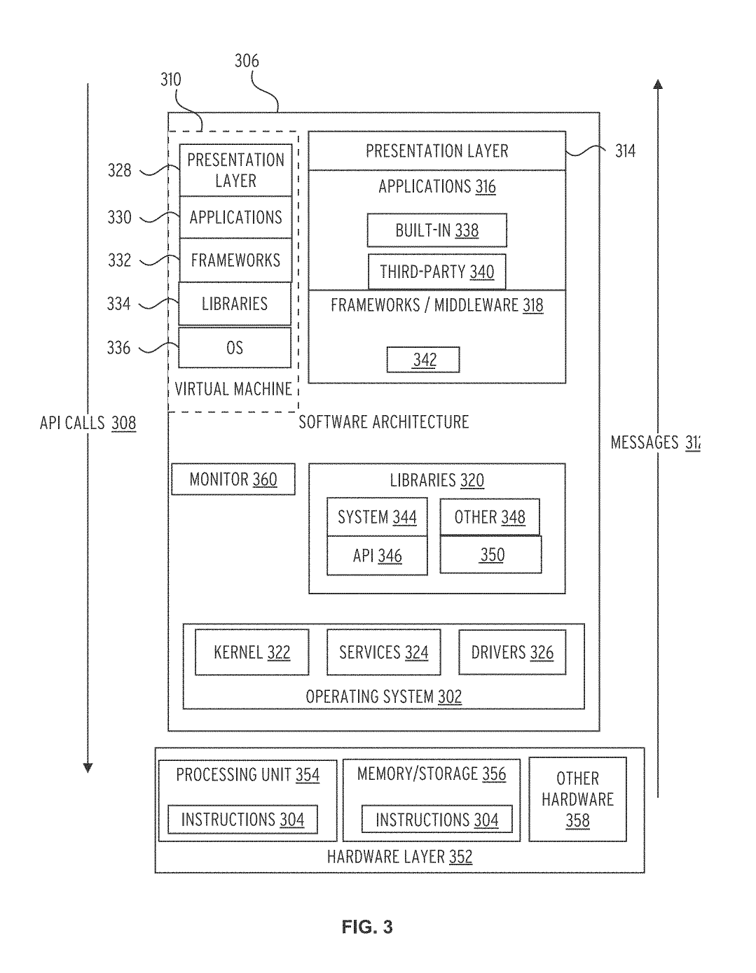

FIG. 3 is a block diagram illustrating an example software architecture 306, which may be used in conjunction with various hardware architectures herein described. FIG. 3 is a non-limiting example of a software architecture and it will be appreciated that many other architectures may be implemented to facilitate the functionality described herein. The software architecture 306 may execute on hardware such as machine 200 of FIG. 2 that includes, among other things, processors 204, memory 214, and I/O components 218. A representative hardware layer 352 is illustrated and can represent, for example, the machine 200 of FIG. 2. The representative hardware layer 352 includes a processing unit 354 having associated executable instructions 304. Executable instructions 304 represent the executable instructions of the software architecture 306, including implementation of the methods, components and so forth described herein. The hardware layer 352 also includes memory and/or storage components memory/storage 356, which also have executable instructions 304. The hardware layer 352 may also comprise other hardware 358.

In the example architecture of FIG, 3, the software architecture 306 may be conceptualized as a stack of layers where each layer provides particular functionality. For example, the software architecture 306 may include layers such as an operating system 302, libraries 320, applications 316 and a presentation layer 314. Operationally, the applications 316 and/or other components within the layers may invoke application programming interface (API) API calls 308 through the software stack and receive a response as in response to the API calls 308. The layers illustrated are representative in nature and not all software architectures have all layers. For example, some mobile or special purpose operating systems may not provide a frameworks/middleware 318, while others may provide such a layer. Other software architectures may include additional or different layers.

The operating system 302 may manage hardware resources and provide common services. The operating system 302 may include, for example, a kernel 322., services 324 and drivers 326. The kernel 322 may act as an abstraction layer between the hardware and the other software layers. For example, the kernel 322 may be responsible for memory management,

processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than to interface directly with the underlying operating system 302 functionality (e.g., kernel 322, services 324 and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/components.

The frameworks frameworks/middleware 318 (also sometimes referred to as middleware) provide a higher-level common infrastructure that may be used by the applications 316 and/or other software components/components. For example, the frameworks/middleware 318 may provide various graphic user interface (GUI) functions, high-level resource management, high-level location services, and so forth. The frameworks/middleware 318 may provide a broad spectrum of other APIs that may be utilized by the applications 316 and/or other software components/components, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, and/or a game application. Third-party applications 340 may include any an application developed using the ANDROID™ or IOS™ software development kit (SDK) by an entity other than the vendor of the particular platform, and may be mobile software running on a mobile operating system such as IOST™, ANDROID™, WINDOWS® Phone, or other mobile operating systems. The third-party applications 340 may invoke the API calls 308 provided by the mobile operating system (such as operating system 302) to facilitate functionality described herein.

The applications 316 may use built in operating system functions(e.g., kernel 322, services 324 and/or drivers 326), libraries 320, and frameworks/middleware 318 to create user interfaces to interact with users of the system, Alternatively, or additionally, in some systems interactions with a user may occur through a presentation layer, such as presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 200 of FIG. 2, for example). The virtual machine 310 is hosted by a host operating system (operating system (OS) 336 in FIG. 3) and typically, although not always, has a virtual machine monitor 360, which manages the operation of the virtual machine as well as the interface with the host operating system (i.e., operating system 302). A software architecture executes within the virtual machine 310 such as an operating system operating system (OS) 336, libraries 334, frameworks 332, applications 330 and/or presentation layer 328. These layers of software architecture executing within the virtual machine 310 can be the same as corresponding layers previously described or may be different.

In this disclosure, several challenges are addressed in providing item recommendations to users in real time that are specific to the scale and variety of this data. Conventional is limited structured data coverage of items which makes it difficult to utilize specific item attributes. Additionally, many items tend to be short-lived as they surface on the site for one day or week and are never listed again. Traditional collaborative filtering (CF) algorithms are not practical to implement due to this volatility of inventory and limitation of structured data coverage,

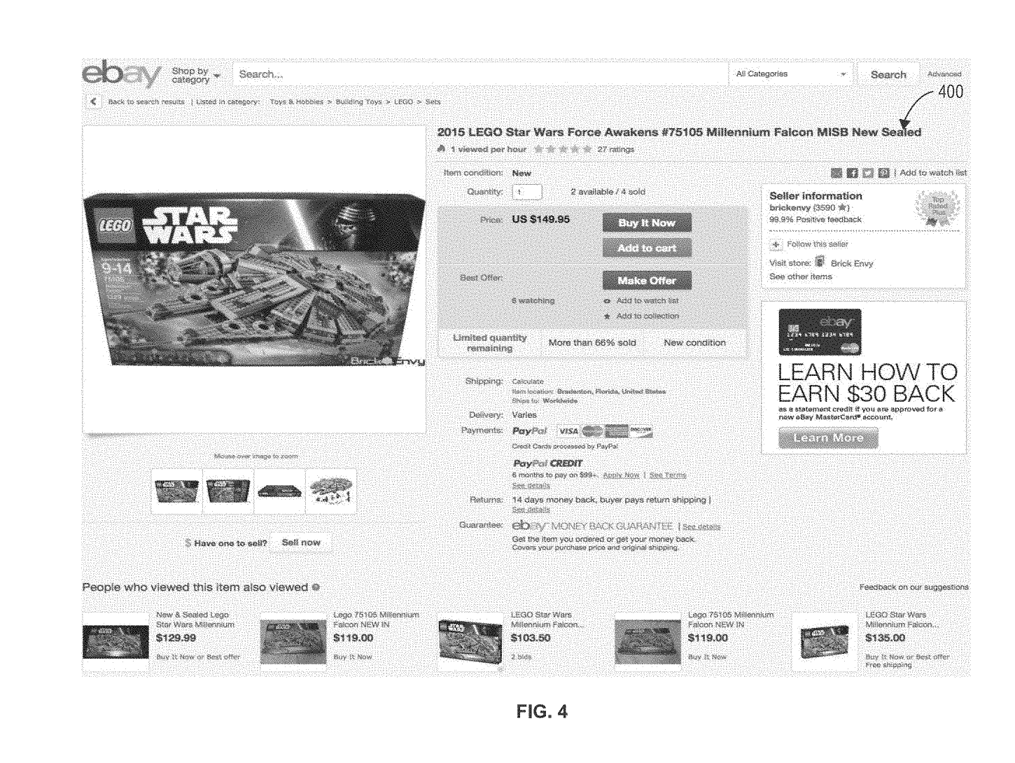

While the recommendations disclosed herein are driven through a large number of channels, including site, mobile and emails, the problems are discussed in relation to an example “most viewed” placement, such as an example item page 400 shown in FIG. 4, This page shows the details of a seed item, with five recommendations shown above the fold (i.e. visible in the screen without requiring scroll up). The general appearance of the example item page 400 is conventional, but the way the item recommendations are derived is not. At one level, the recommendations are produced based on both item similarity and likelihood of purchase. At other levels, more detailed algorithms and recommendation aspects are utilized. Other placements on this site target more diverse recommendations. Past analysis showed that most users look for the same or similar product to the seed in this placement.

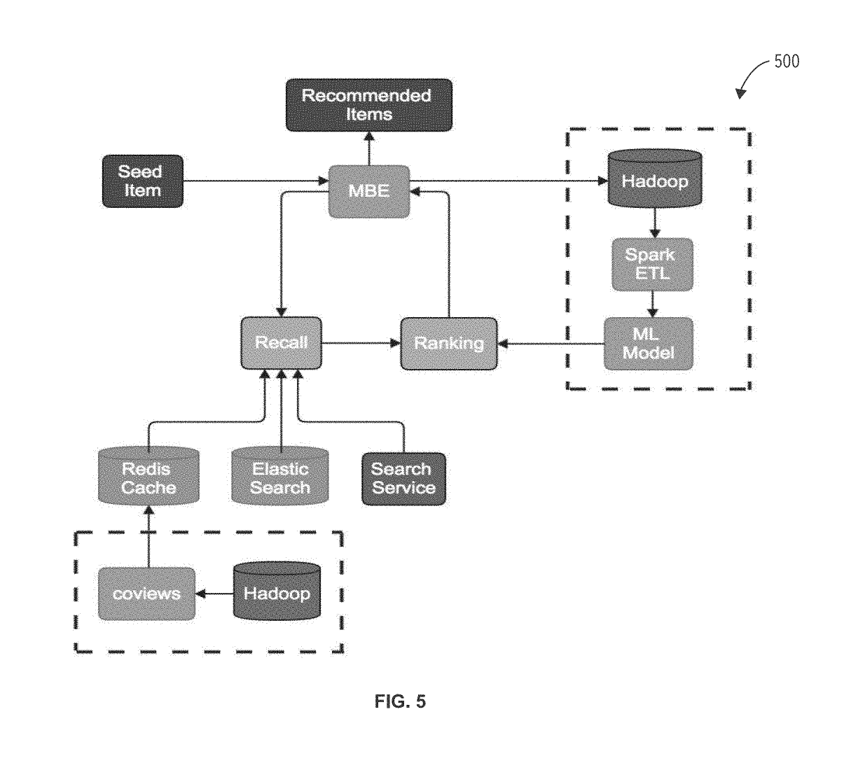

In one example, a two stage algorithm is used in which a subset of items relevant to the seed item is first retrieved, and then ranked to maximize the probability of item conversion. The engineering details of the algorithm architecture are discussed further below in relation to FIG. 5.

The second stage of the algorithm involves ranking the recommendations deciding which top five items (in our example) to show to the user. Fewer or more item recommendations are possible. A pointwise learning-to-rank problem in an information retrieval (IR) context can be reduced to a classification problem using xᵢ={query, URL}ᵢ pairs as well as a binary or multi-class relevance label yᵢ as training input. Assigning relevance labels to query-URI, pairs can be done with crowdsourcing methods but these can sometimes be time consuming and cost prohibitive. In the context of recommendation systems for this disclosure, the classification problem uses xᵢ={seed item, recommended item}ᵢ pairs as well as implicit user feedback (for example, clicks or purchases) as a binary class label as the basic data unit. This way, data collection is continuous and uses real-world conditions. This disclosure provides details herein of why “non-clicks” and “purchases” were selected as class labels for the binary classifier used for ranking recommendations. The details of the ranking approach as well as experimental results are also presented herein.

With reference again to FIG. 5, an example backend platform serves approximately 400 million requests every day and is optimized to have a response time of under 200 ms end-to-end. The backend architecture for the recommendation engine is divided into offline and online systems. An offline phase in one example indexes incoming data, mines behavioral data and click logs, as well as trains a classifier based on historical data to determine likelihood of purchase. Viewed in one way, the overall recommendation process ca be seen as a form of search, which includes two phases: recall, which requires retrieving candidate items that might be similar to the given seed item, and ranking, which sorts the candidates according to their relevance and/or probability of being purchased.

A general overview of the backend architecture can be seen in FIG, 5. The merchandising backend (MBE) receives a call for recommendation for a given seed item. This initiates parallel calls to several services which generates candidate recommendations that are similar in some way to the seed. The set of candidate recommendations are then ranked in real time and the top five are surfaced to the user (buyer).

An example recall phase is now described. With a rather sparse inventory of known products, an item catalog may serve only a small portion of item similarity recommendations on the site. Specifically, on a most viewed placement on the item page 400, less than 15% of recommendations (by impression count) come from the internal product catalog. This sparsity drove the development of a variety of techniques in generating candidate recommendations for a given seed item.

In relation to co-viewed items, a co-view item pair is a pair of items which have been frequently viewed together in the same session by multiple users. The co-view behavioral model has been used across many recommender systems that use collaborate filtering. In one example setting, this disclosure employs a more rudimentary form of filtering and searches for items that have been viewed together with the seed. Due to the volatile nature of the inventory, one example employs a lambda architecture to process session logs in real-time and batch. To ensure similarity, the example also filters out co-viewed items that may be from a different item category then the seed item.

In relation to title similarity, searching for items with a similar title yields a fairly large recall set. Unlike keyword searches, item titles tend to be much longer and hence, in some instances, core search functionality was not a scalable option. In order to accommodate this type of search, one example indexes items in an Elasticsearch database (for example), sharded by its site (country) and category. As this example problem setting includes a given seed item with a specific site and category, an example method can narrow the search focus to only items within the same domain. This kind of sharding allows search latencies to fit within a desired range, for example a 100 ms range. In some examples, the quality of the returned recommendations is higher than previous approaches which use locality sensitive hashing (LSH), based on the item's title. Elasticsearch's indexing scheme uses TF IDF based weightings in order to calculate relevance scores. Using co-views and title-similarity based methods increased total recall significantly and made up to 90% of the recommendations.

In an example ranking phase, user impressions interactions (which include clicks and purchases) are logged to a Hadoop cluster for analysis. Apache Spark is used for Extract, Transform and Load (ETL) where the user logs are joined with item details and the data is subsampled. The trained offline MLR model parameters are passed to the runtime ranking application where predictions are made in real time.

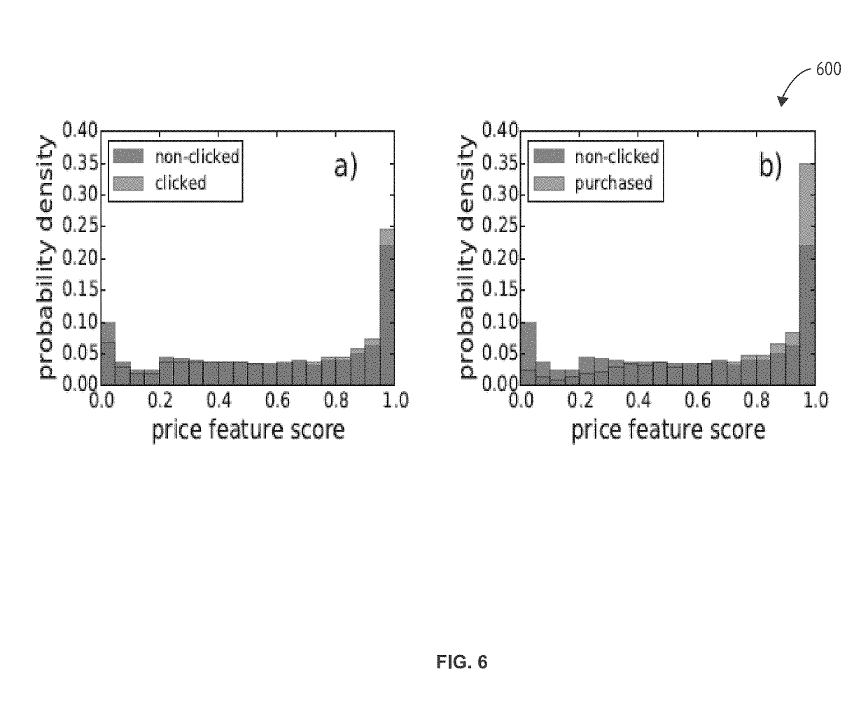

An example ranking model is now described with reference to FIGS. 6-8. The learning-to-rank problem, in the context of recommendations, is reduced to a binary classification problem where, in one example, recommendations on the probability of being purchased are ranked. The sampling strategy as well as the engineering of specific features can be important to the success of any classifier, Details of an example modeling approach are given below.

In one example, a binary classifier is trained based on user browsing and purchase logs. Initially, one example considered using “non-clicked” and “clicked” as class labels for the model and ranked the recommendations by the probability of click. In order to investigate the effectiveness of this strategy the inventors looked at the class separability of each feature.

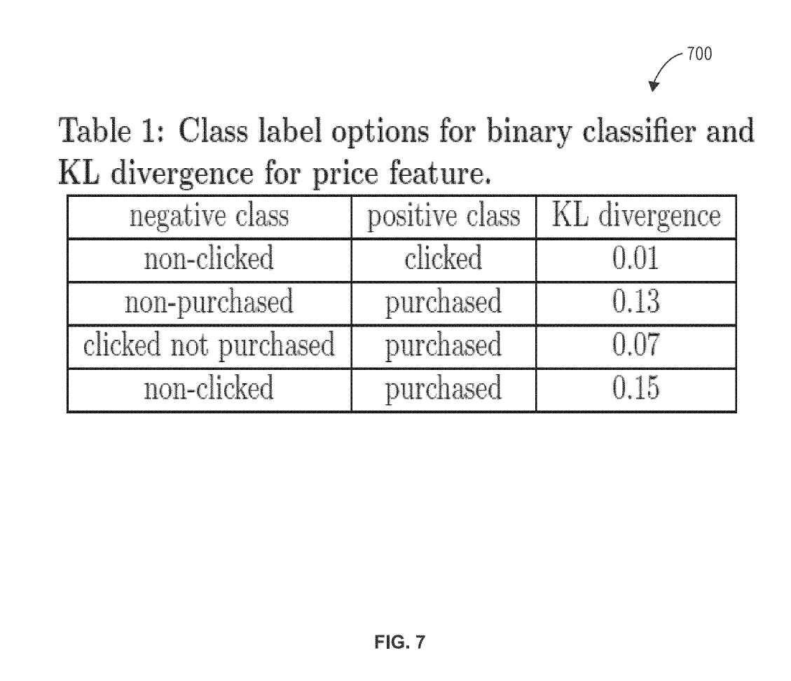

FIG. 6a) shows a histogram of a price feature score (described in the next section) for the non-clicked/clicked sampling strategy, User click patterns tend to be noisy as users browse items in a marketplace for a variety of reasons. This leads to the classes not separating well. A Kullback-Leibler (KL) divergence score was used to identify a quantitative measure of the overlap of the probability distributions for the two classes. Table 1 in FIG. 7 shows several possibilities for choosing classes as well as the resulting KL divergence scores for the price feature.

FIG. 6b) shows a histogram for an alternate non-clicked/purchased sampling strategy. The inventors ran this type of analysis, looking at the KL divergence score, for all of the features in their model in order to validate that the non-clicked/purchased is optimal for class separation. This can make sense in terms of user intention as non-clicked recommendations show (in theory) absolutely no user interest while the purchased recommendations indicate complete user intention (conversion). Clicked recommendations are in the middle of this spectrum and cannot be used as effectively for classification. Class separation is important for effective classifier performance. Another important property is distribution of classes in the sample. Purchase events tend to be an order of magnitude lower than clicked recommendations which themselves occur in a relatively low portion of impressions. Due to this extreme class imbalance, the inventors sub-sampled the negative class to be balanced with the positive class.

In relation to feature engineering, there are two types of features in the model, comparison features and item quality features. Comparison features compare properties of the seed item to the possible recommendation item. Some examples of this include comparing price, condition, format, and titles (using TF-IDF based methods). The item quality features are designed to ensure higher quality items are surfaced to the user. These features include popularity and seller feedback of the item seller, among others.

The details of an important comparison feature, namely a price feature, are now discussed. Prices of identical items can vary by orders of magnitude because of condition or simply due to preference of the seller, instead of directly comparing the seed item price, p_{seed}, to the recommended item price, p_{reco}, an example embodiment instead models the ratio p_{reco}/P_{seed} which is centered near unity.

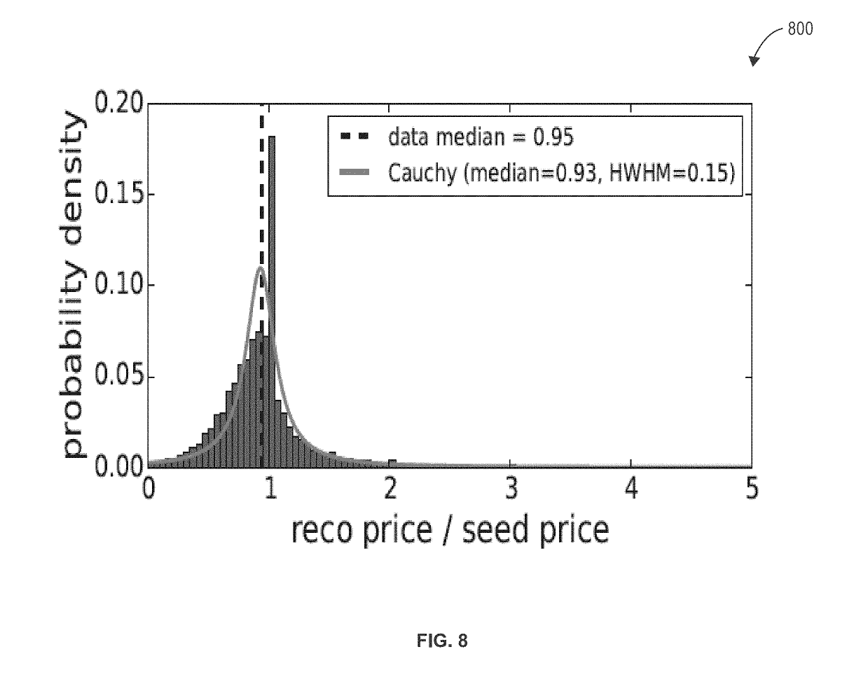

FIG. 8 shows a normalized histogram of the price ratio (blue bars) from past purchase events, where the user viewed the seed item and then purchased the recommended item. An example embodiment models this data with a Cauchy distribution which has a probability density function of the following form:

$${f}_{Cauchy} ( x , {x}_{0} , γ ) = \frac{1}{πγ [ 1 + {( \frac{x - {x}_{0}}{γ} )}^{2} ]} \qquad ( 1 )$$

where x₀ is the median and is the Half Width at Half Maximum (HWHM). Other distributions such as the Gaussian, Gamma, and Weibull, can be employed however, the Cauchy has the best fit to the past purchase data. The price feature score is then generated from a normalized Cauchy distribution S_{price}=f_{couchy}(x; i₀, γ)·πγ to be 1 when p_{reco}=p_{seed} and smoothly transitioning to 0 otherwise.

The baseline ranking model that is used for comparison is a linear model with manually adjusted weights based on input from domain experts and human judgement of test output.

Potential recommendations are ranked based on highest global score, G=Σⱼ₌₁^{N}wⱼ·sⱼ, where wⱼ and sⱼ are the weight and feature score, respectively. One example embodiment defines normalizations on the weights Σⱼ₌₁^{N}wⱼ=1 and feature scores 0≦sj≦1 which results in a constraint on the global score 0≦G≦1. This example model was launched in test conditions in order to validate effectiveness of the features as well as gather data in order to address any cold start problems.

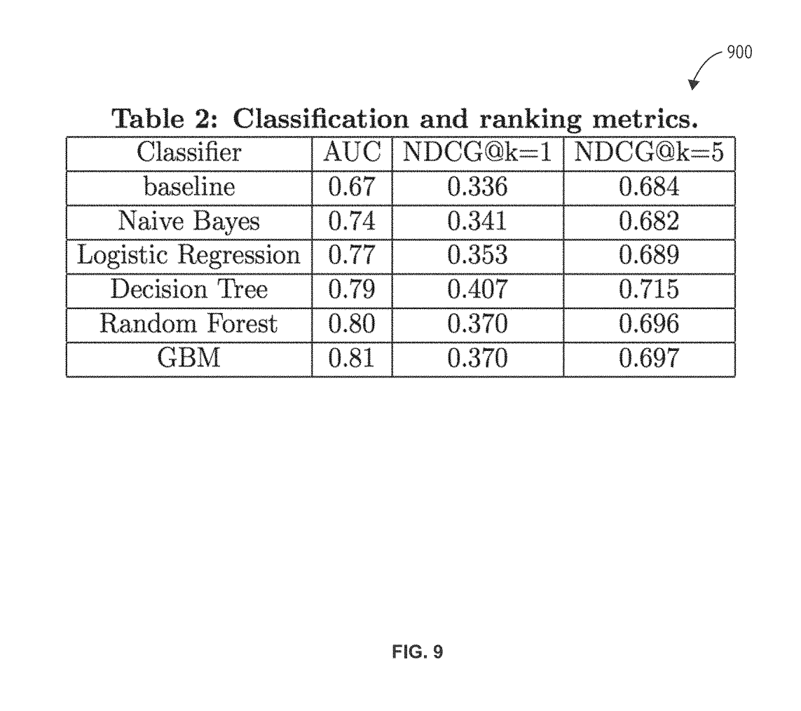

The performance of several classifiers on the balanced dataset with the non-clicked/purchased class labels can also be evaluated. In one example, a dataset containing 352,070 examples was gathered over ten days of user logs and was randomly split into training (60%) and validation (40%) sets. Table 2 in FIG. 9 shows the ROC and AUC scores from the validation data set demonstrating improved performance over the baseline model. The hyper-parameters for the tree based classifiers were optimized using a grid search. The accuracy (0.70) as well as the positive class precision (0.70) and recall (0.70) for the logistic regression indicated reasonable classification performance.

Recommendations are ranked by the probability of purchase (positive class), effectively maximizing conversion. To evaluate ranking performance, the inventors took raw un-sampled recommendations from impressions that contained a purchase, excluding impressions used for training and used a variation of the discounted cumulative gain (DCG) metric:

$$DCG = {\sum }_{i = 1}^{n} \frac{{2}^{{l}_{i}} - 1}{{log}_{2} ( {r}_{i} ) + 1} \qquad ( 2 )$$

where rᵢ and lᵢ is the rank and relevance of the recommendation and n is the maximum rank. The normalized DCG (NDCG), which normalizes the DCG by the ideal ordering, is typically used for evaluating ranking performance. Since most impressions have only one purchase, the inventors used the NDCG@=1 metric which truncates the DCG summation at k=1. The inventors defined the relevance function to be {non-clicked=0, clicked=0, purchased=1}. The model was evaluated on ten datasets with user log data from different time frames and countries. Classification and ranking performance was comparable to the results shown in Table 2.

In relation to A/B test results, one example segments the model by product category and country. An individual classifier was trained in every major category as users tend to shop differently in different domains (for example, prices may be more important in clothing versus antiques).

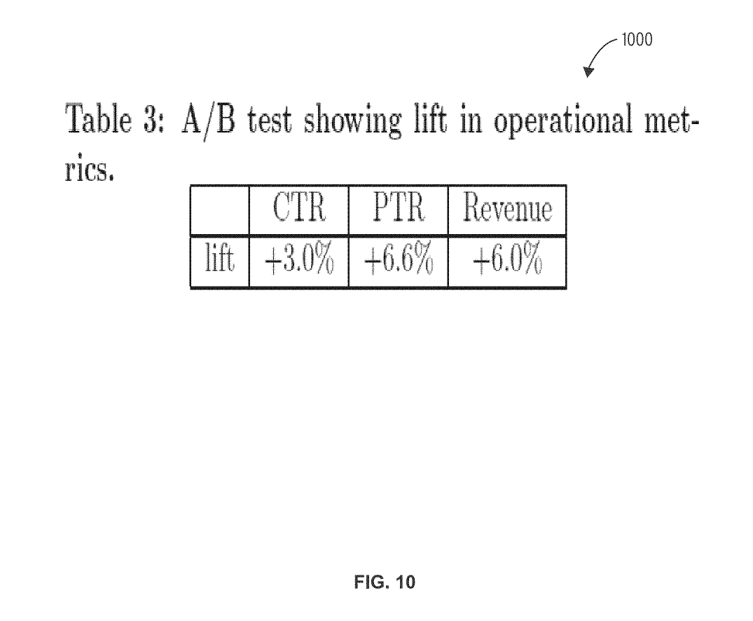

One example implemented a logistic regression model for a production platform due to its scalability and reasonable classification and ranking performance compared to tree based classifiers. The country and category segmented MLR model was A/B tested in live production traffic with the control being the baseline model defined further above. Table 3 in FIG. 10 shows positive lift in the critical operational metrics click through rate (CTR), purchase through rate (PTR), and revenue. The model was optimized to maximize conversion which can be seen in the increase in PTR (+6.6%) and revenue (+6.0%). This machine learned ranking model was launched to full production traffic on an item page worldwide in eight countries including US, UK, and Germany.

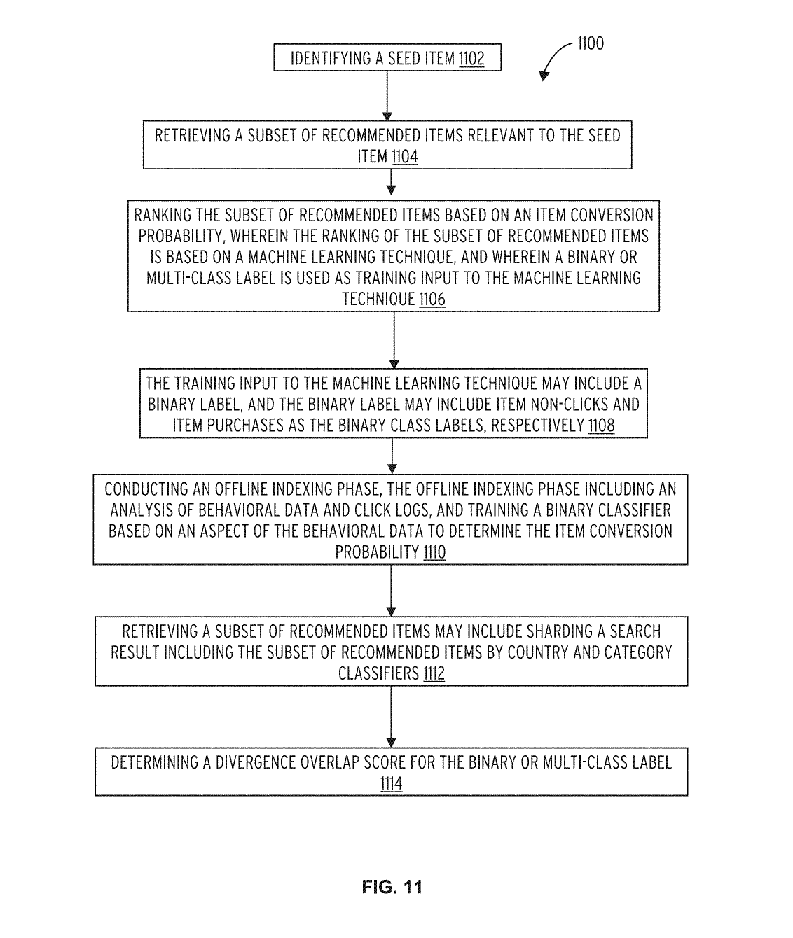

Some embodiments include methods. With reference to FIG. 11, a method 1100 of optimizing similar item recommendations in a semi-structured environment includes, at 1102, identifying a seed item; at 1104, retrieving a subset of recommended items relevant to the seed item; and at 1106 ranking the subset of recommended items based on an item conversion probability, wherein the ranking of the subset of recommended items is based on a machine learning technique, and wherein a binary or multi-class label is used as training input to the machine learning technique. At 1108, the training input to the machine learning technique may include a binary label, and the binary label may include item non-clicks and item purchases as the binary class labels, respectively.

The method 1100 may further comprise, at 1110, conducting an offline indexing phase, the offline indexing phase including an analysis of behavioral data and click logs, and training a. binary classifier based on an aspect of the behavioral data to determine the item conversion probability. In operation 1112, retrieving a subset of recommended items may include sharding a search result including the subset of recommended items by country and category classifiers. The method 1100 may further comprise, at 1114, determining a divergence overlap score for the binary or multi-class label. In a further operation, a determination of the item conversion probability may be based on a metric including

$$DCG = {\sum }_{i = 1}^{n} \frac{{2}^{{l}_{i}} - 1}{{log}_{2} ( {r}_{i} ) + 1} \qquad ( 2 )$$

where ri and li is a rank of a recommended item and n is a maximum rank.

The inventors thus disclose, in some embodiments, a custom, highly scalable architecture which can produce high quality similar item recommendations in a diverse semi-structured marketplace. The inventors have developed a widely applicable and interpretable pointwise machine learned ranking model trained on implicit user shopping behavior. The model optimizes recommendation rank based on probability of purchase.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” or “example” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for optimizing similar item recommendations in a semi-structured environment, the system including:
at least one processor;
a memory storing instructions that, when executed by the at least one processor, cause the system to perform operations comprising, at least:
identifying a seed item;
retrieving a subset of recommended items relevant to the seed item; and
ranking the subset of recommended items based on an item conversion probability, wherein the ranking of the subset of recommended items is based on a machine learning technique, and wherein a binary or multi-class label is used as training input to the machine learning technique.

2. The system of claim 1, wherein the training input to the machine learning technique includes a binary label, and wherein the binary label includes item non-clicks and item purchases as the binary class labels, respectively.

3. The system of claim 1, wherein the operations further comprise:
conducting an offline indexing phase, the offline indexing phase including an analysis of behavioral data and click logs; and
training a binary classifier based on an aspect of the behavioral data to determine the item conversion probability.

4. The system of claim 1, wherein retrieving a subset of recommended items includes sharding a search result including the subset of recommended items by country and category classifiers.

5. The system of claim 1, wherein the operations further comprise determining a divergence overlap score for the binary or multi-class label.

6. The system of claim 1, wherein a determination of the item conversion probability is based on a metric including
$$DCG = {\sum }_{i = 1}^{n} \frac{{2}^{{l}_{i}} - 1}{{log}_{2} ( {r}_{i} ) + 1} \qquad ( 2 )$$
where rᵢ and lᵢ is a rank of a recommended item and n is a maximum rank.

7. A method of optimizing similar item recommendations in a semi-structured environment, the method including:
identifying a seed item;
retrieving a subset of recommended items relevant to the seed item; and
ranking the subset of recommended items based on an item conversion probability, wherein the ranking of the subset of recommended items is based on a machine learning technique, and wherein a binary or multi-class label is used as training input to the machine learning technique.

8. The method of claim 7, wherein the training input to the machine learning technique includes a binary label, and wherein the binary label includes item non-clicks and item purchases as the binary class labels, respectively.

9. The method of claim 7, wherein the method further comprises:
conducting an offline indexing phase, the offline indexing phase including an analysis of behavioral data and click logs; and
training a binary classifier based on an aspect of the behavioral data to determine the item conversion probability.

10. The method of claim 7, wherein retrieving a subset of recommended items includes sharding a search result including the subset of recommended items by country and category classifiers.

11. The method of claim 7, wherein the method further comprises determining a divergence overlap score for the binary or multi-class label.

12. The method of claim 7, wherein a determination of the item conversion probability is based on a metric including
$$DCG = {\sum }_{i = 1}^{n} \frac{{2}^{{l}_{i}} - 1}{{log}_{2} ( {r}_{i} ) + 1} \qquad ( 2 )$$
where rᵢ and lᵢ is a rank of a recommended item and n is a maximum rank.

13. A non-transitory machine-readable storage medium storing a set of instructions that, when executed by at least one processor, causes the at least one processor to perform operations including, at least:
identifying a seed item; and
retrieving a subset of recommended items relevant to the seed item; and
ranking the subset of recommended items based on an item conversion probability, wherein the ranking of the subset of recommended items is based on a machine learning technique, and wherein a binary or multi-class label is used as training input to the machine learning technique.

14. The medium of claim 13, wherein the training input to the machine learning technique includes a binary label, and wherein the binary label includes item non-clicks and item purchases as the binary class labels, respectively.

15. The medium of claim 13, wherein the operations further include:
conducting an offline indexing phase, the offline indexing phase including an analysis of behavioral data and click logs; and
training a binary classifier based on an aspect of the behavioral data to determine the item conversion probability.

16. The medium of claim 13, wherein retrieving a subset of recommended items includes sharding a search result including the subset of recommended items by country and category classifiers.

17. The medium of claim 13, wherein the operations further include determining a divergence overlap score for the binary or multi-class label.

18. The system of claim 1, wherein a determination of the item conversion probability is based on a metric including
$$DCG = {\sum }_{i = 1}^{n} \frac{{2}^{{l}_{i}} - 1}{{log}_{2} ( {r}_{i} ) + 1} \qquad ( 2 )$$
where rᵢ and lᵢ is a rank of a recommended item and n is a maximum rank.
